(19) United States
(12) Patent Application Publication
(10) Pub. No.: US 2008/0005100 A1
(43) Pub. Date: Jan. 3, 2008

(54) MULTIMEDIA SYSTEM AND MULTIMEDIA SEARCH ENGINE RELATING THERETO

(75) Inventor: Yung-Chang Hsu, Taichung City (TW)

Correspondence Address: PAI PATENT & TRADEMARK LAW FIRM, 1001 FOURTH AVENUE, SUITE 3200, SEATTLE, WA, 98154, US

(73) Assignee: ThereYuGo, Inc., Taichung City (TW)

(21) Appl. No.: 11/763,246

(22) Filed: Jun. 14, 2007

(30) Foreign Application Priority Data
Jun. 20, 2006 (TW) 95122162
May 28, 2007 (TW) 96119004

(51) Int. Cl. G06F 17/30

(52) U.S. Cl. 707/5; 707/E17.017

(57) ABSTRACT

A multimedia system including a system database, an input module, a search module and an output module is provided. At least one multimedia content and its subtitle file are stored in the system database firstly. The subtitle file has a plurality of start times and subtitles of segments. A keyword is input in the input module and the segments having the keyword are searched from the subtitle files of the system database by the search module. The segments having the keyword and their subtitles are output by the output module finally. A multimedia search engine is also disclosed therein.

### RELATED APPLICATIONS

This application claims priority to Taiwan Application Serial Number 95122162, filed Jun. 20, 2006, and Taiwan Application Serial Number 96119004, filed May 28, 2007. All of these applications are incorporated herein by this reference.

### BACKGROUND

1. Field of Invention

The present invention relates to a multimedia system and a multimedia search engine relating thereto. More particularly, the present invention relates to a multimedia system a multimedia search engine relating thereto that includes a function of searching subtitle.

2. Description of Related Art

Language is an important tool of human communication. In the trend of globalization, there is a longing for conversation with people in different language for language learners. Utilization of multimedia is a good way for language learning beyond the limitation of time and location. Further, utilization of multimedia could provide a way for language learners to learn the language step by step from the easy to the difficult and complicated. Hence it is advantageous to the learner to know the content well. However, the current multimedia teaching materials for learning language are usually boring and insipid to the learner.

Multimedia data includes at least two types of media, composed of such as written words, charts, images, sounds and animation. For example, multimedia such as movies, animation, documentary films, television movies and music that include static images, dynamic images and sounds are indeed the best teaching material for language learning. Listening and watching the multimedia in foreign language may help to experience the tone and manner of speaking a word or a sentence. Further, the abundant content is helpful to excite the learners. For the multimedia data that include subtitle files, the subtitle may be integrated with sounds and dynamic images such that it is easier for the learners to learn language. However, the main function of multimedia in the prior art is not language learning. When the user wants to study a certain word and sentence, he would not be able to search the subtitle of the multimedia by a keyword.

For the forgoing reasons, there is a need for a multimedia system that is provided to the user to study language via multimedia for sensing and feeling the tone and manner for speaking the language. Besides, the multimedia system may further provide a searching function to the subtitle of multimedia in the system for learning specific words and sentences, which is expected by the language learners, and is also expected by the users who search films and songs through Internet.

### SUMMARY

It is therefore an aspect of the present invention to provide a multimedia system that converts the abundant content of the multimedia data and its subtitle file into teaching material of language, such that the learners may feel and sense the tone and manner for speaking the language and be excited to learn.

It is another aspect of the present invention to provide a multimedia system. The multimedia system includes a plurality of multimedia segment and the subtitle file thereof. The user may utilize a keyword to search in the data of the subtitle file of the multimedia system for learning specific words and sentences.

It is still another aspect of the present invention to provide a multimedia search engine. By inputting a keyword through Internet and computer, the multimedia search engine provides a searching function to the subtitle files and further shows specific multimedia segments of films or songs which have the same keyword or the like.

In accordance with the foregoing and other aspects of the present invention, a multimedia system and the related multimedia search engine are provided. The multimedia system comprises a system database, an input module, a search module and an output module. The system database is utilized to store at least one multimedia data and a subtitle file of the multimedia data, wherein the subtitle file comprises start times, end times and subtitles of a plurality of segments of the multimedia data. The input module is for inputting a keyword. The search module is for utilizing the keyword to search the subtitle file in the system database for finding a segment that comprises the keyword. The output module is for outputting the segment and subtitle that comprises the keyword. The method for playing multimedia data includes the following steps. First, store at least one multimedia data and a subtitle file of the multimedia data in a system database, wherein the subtitle file comprises start times, end times and subtitles of a plurality of segments of the multimedia data. Next, input a keyword and search a start time, an end time and subtitle of a segment that comprises the keyword in the system database by utilizing the keyword. Finally, repeatedly output the segment and the subtitles that comprise the keyword.

The multimedia system and the related multimedia search engine of the present invention may convert content and subtitles of the numerous multimedia into teaching material of languages, such that excites the user to learn. Besides, the user may utilize a keyword to search in the subtitle file of the multimedia system for learning specific words and sentences.

According to a preferred embodiment of the present multimedia system and the related multimedia search engine, the input module includes a segment length input unit for controlling the length of the subtitle and the segment output by the output module. By the segment length input unit, the user may control the length of the content displayed by the multimedia system, and further utilize the content of the segment to study more efficiently.

According to a preferred embodiment of the present multimedia system and the related multimedia search engine, the system database includes a historic data list for storing part of the data set, and the output module includes a historic data displayer for displaying the data of the historic data list. The user may select a serial number of the content displayed by the historic data displayer any time for reviewing the multimedia segment and subtitles that have been retrieved.

According to a preferred embodiment of the present multimedia system and the related multimedia search engine, the languages of the subtitle file include English, Chinese, Japanese, Korean, Russian, German, French, Arabic, Italian, Portuguese and Spanish. The data of the subtitle file is encoded by Unicode. Besides, the present multimedia system includes a translating module for converting the language of the keyword. The present multimedia system may convert the keyword into different languages by the translating module. The present multimedia system may display words of different languages for the user to study language more conveniently.

These and other features, aspects, and advantages of the present invention will become better understood with reference to the following description, figures, and appended claims.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a method flow diagram of a method for playing multimedia data according to one preferred embodiment of this invention;

FIG. 2 is a block diagram of a multimedia system according to one preferred embodiment of this invention;

FIG. 3 is a structure diagram of a user interface according to one preferred embodiment of this invention;

FIG. 4 is a block diagram of a multimedia system according to one preferred embodiment of this invention;

FIG. 5 is a block diagram of a multimedia system according to one preferred embodiment of this invention;

FIG. 6 is a search screen for a multimedia search engine according to one preferred embodiment of this invention; and

FIG. 7 is a search result screen for a multimedia search engine according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Multimedia such as movies, animation, documentary films, television movies and music that include static images, dynamic images and sounds are indeed good teaching material for language learning. However, the conventional multimedia players are only able to play contents the multimedia in order, which does not satisfy the user who wants to learn language. For example, the user cannot utilize a keyword to retrieve the subtitle of the multimedia data for learning specific words and sentences. The present multimedia system may store data of the multimedia and its subtitle file in the system database for utilize the data of the multimedia and its subtitle file as teaching material for language learning. Further, the keyword may be utilized to retrieve data of the subtitle file in the system database for learning specific words and sentences. Moreover, when the keyword searched by the user is not found in the system database, the present multimedia system may search for the multimedia data required by the user via a remote database.

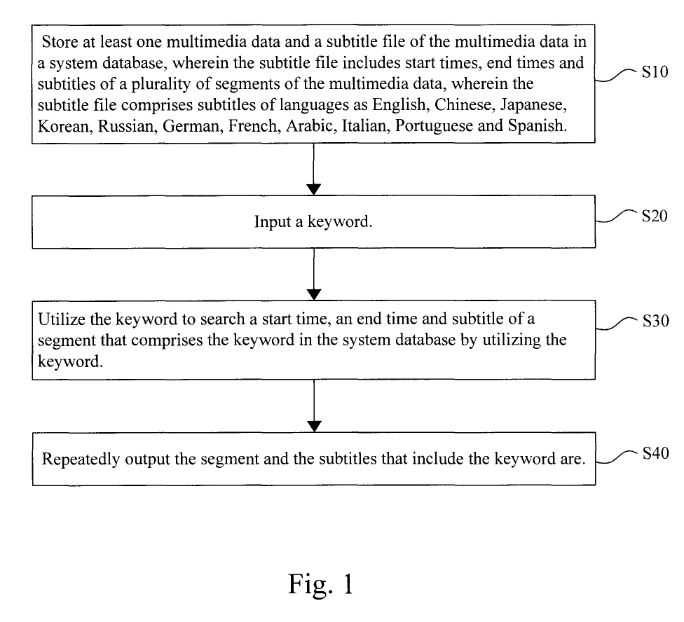

Refer to FIG. 1. FIG. 1 illustrates a method flow diagram of a method for playing multimedia data according to one preferred embodiment of this invention. The method for displaying multimedia includes the following steps. First, at S10, store at least one multimedia data and a subtitle file of the multimedia data in a system database, wherein the subtitle file includes start times, end times and subtitles of a plurality of segments of the multimedia data, wherein the subtitle file comprises subtitles of languages as English, Chinese, Japanese, Korean, Russian, German, French, Arabic, Italian, Portuguese and Spanish. At S20, a keyword is input. Next, the keyword is utilized to search a start time, an end time and subtitle of a segment that comprises the keyword in the system database by utilizing the keyword at S30. Finally, the segment and the subtitles that include the keyword are output repeatedly. In the present method for playing multimedia, data of multimedia and its subtitle file are employed as teaching material for language, and a function of searching by keyword is adopted, such that the segment and the subtitles that include the keyword may be output repeatedly for the user's convenience to learn specific words and sentences by the multimedia segments.

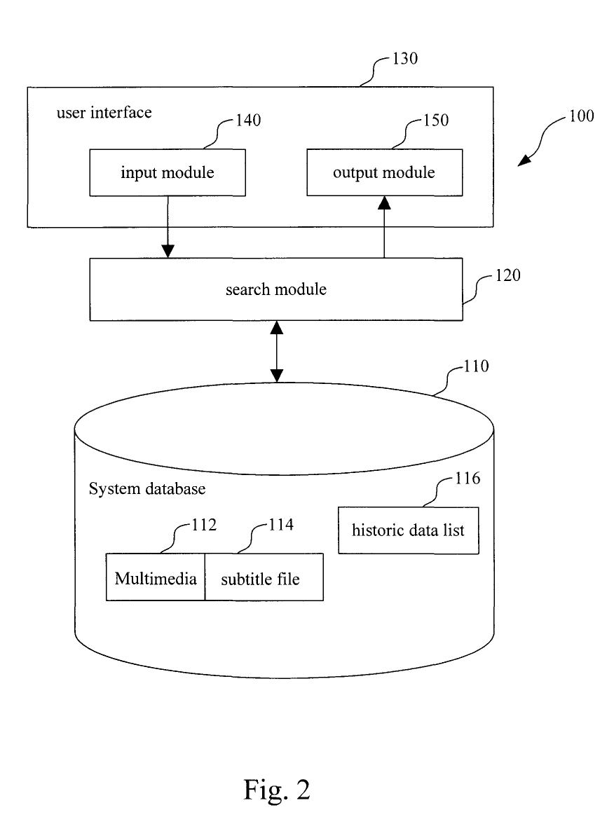

Please refer to FIG. 2. FIG. 2 is a block diagram of a multimedia system according to one preferred embodiment of this invention. The multimedia system 100 is, for example, implemented by software or by hardware circuit. The multimedia system 100 includes a system database 110, a search module 120 and an user interface 130, wherein user interface 130 includes an input module 140 and an output module 150. The system database 110 is utilized for storing at least one multimedia 112 and a subtitle file 114 of the multimedia 112. The subtitle file 114 includes start times, end times and subtitles of a plurality of segments of the multimedia 112. The input module 140 is adopted for inputting a keyword. The search module 120 is utilized to search the system database 110 by a keyword, such that start times and end times of multimedia segments that include the keyword are retrieved. The output module 150 is utilized to output the multimedia segments and their subtitles that include the keyword.

Continue to FIG. 2. The system database 110 is a multimedia movie, stored by DivX format, for example. The subtitle file is a file in SSA format, for example. Please note that, in the subtitle file, the multimedia are divided into a plurality of segments, wherein each multimedia segment correspondingly has a start time, an end time and subtitle. Besides, in the system database 110, there are stored a multimedia title and a serial number of each multimedia segment, wherein the serial number is an identity number of that multimedia segment. By the serial number, the multimedia titles, the start times, the end times and the subtitles of the multimedia segments are indexed.

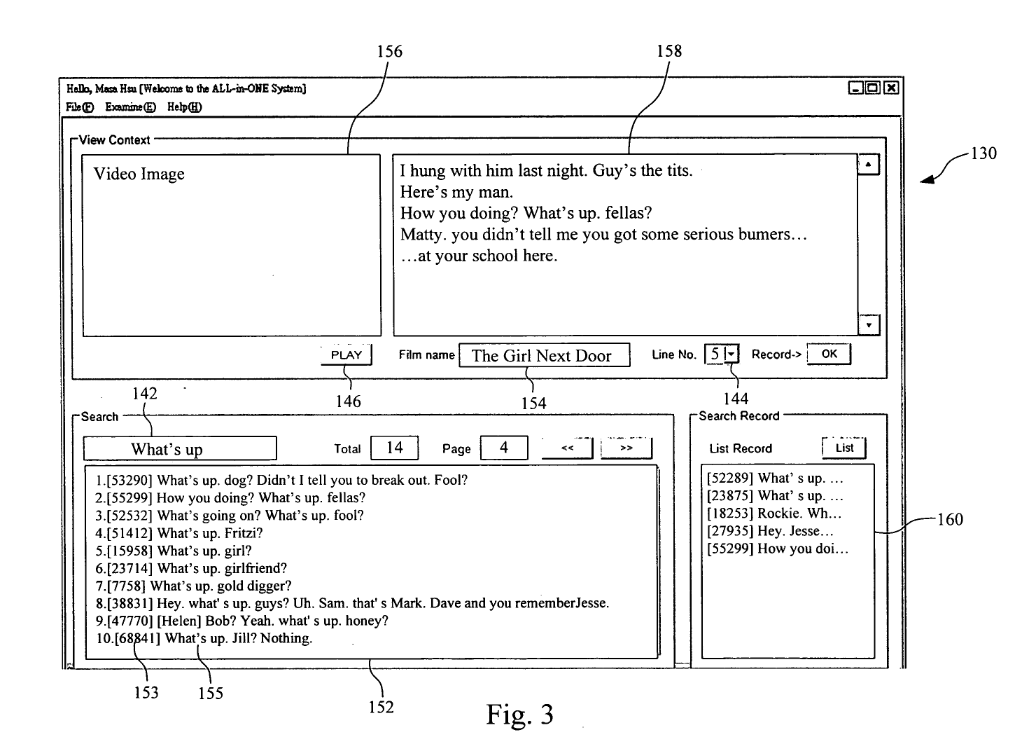

In the system database 110, there are stored the multimedia 112 and the subtitle file 114 of the multimedia 112. The user may input a keyword through the user interface 130, the search module 120 may accordingly search the system database 110, and the search result may displayed in the user interface 130. Refer to FIG. 3. FIG. 3 is a structure diagram of a user interface according to one preferred embodiment of this invention. The input module of the user interface 130 includes a keyword input unit 142 and a segment length input unit 144. The output module includes a search result displayer 152, a multimedia title displayer 154, a multimedia playing unit 156, a subtitle playing unit 158 and a historic data displayer 160. Referring to FIG. 2 and FIG. 3, the operation of the user interface 130 is described as follows. A keyword is received at the keyword input unit 142. Next, a search module 120 is utilized to search for serial numbers, start times, end times and subtitles of the multimedia segments that include the keyword in the system database 110. The search result of the search module 120 is finally displayed in the search result displayer 152.

The search result of the search module 120 is, for example, a data set, including a plurality of data, wherein each data includes a serial number, a start time, an end time and subtitle of the multimedia segment. Hence it is convenient to the user to select one of the data to display the multimedia segment. The search result displayer 152 may present the serial number, for example, in a hyperlink 153, and present the subtitle 155 after the hyperlink 153. When one of the hyperlink 153 is selected, it is displayed in the multimedia title displayer 154 the multimedia title that corresponds to the serial number. The multimedia playing unit 156 utilizes the multimedia title, the start time and the end time to read in the system database 110 for playing the multimedia segment. Besides, the subtitle playing unit 158 reads in the system database 110 to play the subtitle of the multimedia segment. Please note that, the multimedia playing unit 156 is, for example, a DivX decoder, a decoder for formats of the first layer to the fourth layer and the seventh layer of MPEG(Moving Picture Experts Group) files, a decoder for WMV (Windows Media Video) format, a decoder for WMA (Windows Media Audio) format, a decoder for MP3 (MPEG-1 Audio Layer 3) format a decoder for FLV (Flash Video) format, or a combination of the aforementioned decoders. Besides, the color of the words in the subtitle played by the subtitle playing unit 158 may change accordingly to the play point of the multimedia, such that the viewer may know the word being played better. Further, if the user repeatedly presses the play key 146, the multimedia playing unit 156 and the subtitle playing unit 158 may repeatedly play the multimedia segment and its subtitle.

By the aforementioned multimedia system 100, the plenty of the multimedia and their subtitle files are able to be converted into teaching material of language, such that excites the user to learn. Besides, the user may utilize a keyword to search in the subtitle file 114 of the multimedia system 100 in order to learn some specific words and sentences.

The present multimedia system further includes functions of controlling length of the multimedia segment, storing historic data, translating, remote searching and on-line transaction. The aforementioned functions are described as follows.

Refer to FIG. 2 and FIG. 3. The user interface 130 includes a segment length input unit 144 for controlling a length of the multimedia segments played by the multimedia playing unit 156 and a length of the subtitles played by the subtitle playing unit 158. For example, if input a number “5” in the segment length input unit 144, and select a serial number displayed in the search result displayer 152, the multimedia playing unit 156 plays the multimedia segment corresponding to the serial number and two preceding and two following multimedia segments, that is, five multimedia segment in total. More, the subtitle playing unit 158 plays subtitles corresponding to the five multimedia segments. In other words, the bigger the number input, the more the segments played by the multimedia playing unit 156 and the subtitle playing unit 158. By the segment length input unit 144, the user is able to control the length played by the multimedia system 100, and further to study language more efficiently.

Please refer to FIG. 2 and FIG. 3. For the convenience of the user to review the multimedia segments that have been retrieved, the system database 110 further includes a historic data list 116 for storing part of the data set searched by the search module 120. For example, the data which has been selected, stored in the search result displayer 152, may be stored in the historic data list 116. Besides, the output module 150 of the user interface 130 includes a historic data displayer 160. The historic data displayer 160 presents the serial numbers and the corresponding subtitles stored in the historic data list 116. The user may select the serial number displayed in the historic data displayer 160 any time to review the multimedia segment and the subtitle that have been retrieved.

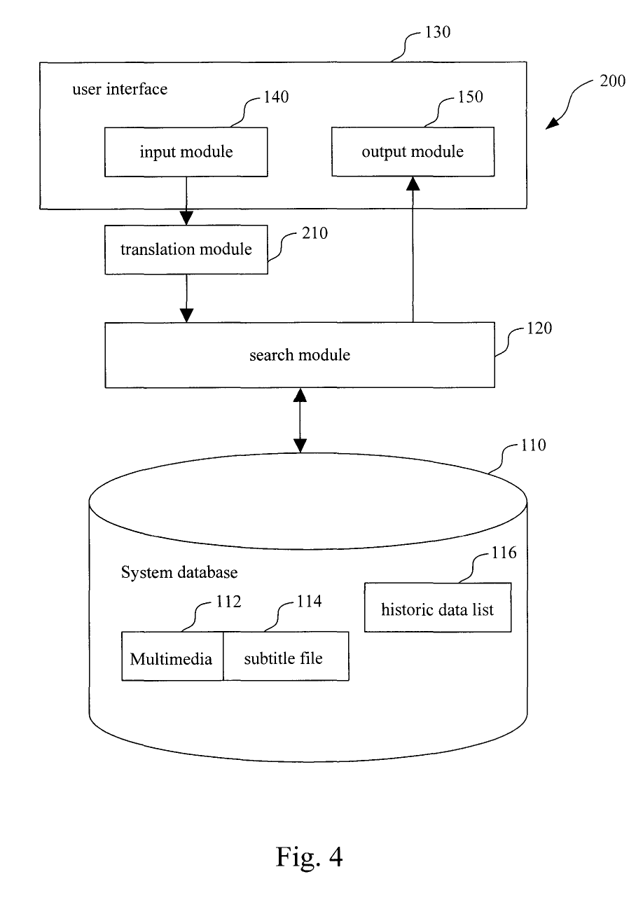

Refer to FIG. 4. FIG. 4 is a block diagram of a multimedia system according to one preferred embodiment of this invention. Languages of the subtitle files include English, Chinese, Japanese, Korean, Russian, German, French, Arabic, Italian, Portuguese and Spanish. The subtitle file 114 of the present multimedia system 200 is encoded by, for example, Unicode, stored in the system database 110. Besides, the multimedia system 200 further includes a translation module 210 for converting the language of the keyword. For example, the user may key in a keyword in Chinese in the keyword input unit 142. The translation module 210 may convert the Chinese keyword into an English work of the same meaning. The search module 120 then utilizes the English keyword to search in the system database 110. Please note that, the subtitle file 114 may be encoded by Unicode and stored in the system database 110. Therefore, the multimedia system 200 may display words of different languages at the same time. Hence it is more advantageous to the user to learn languages.

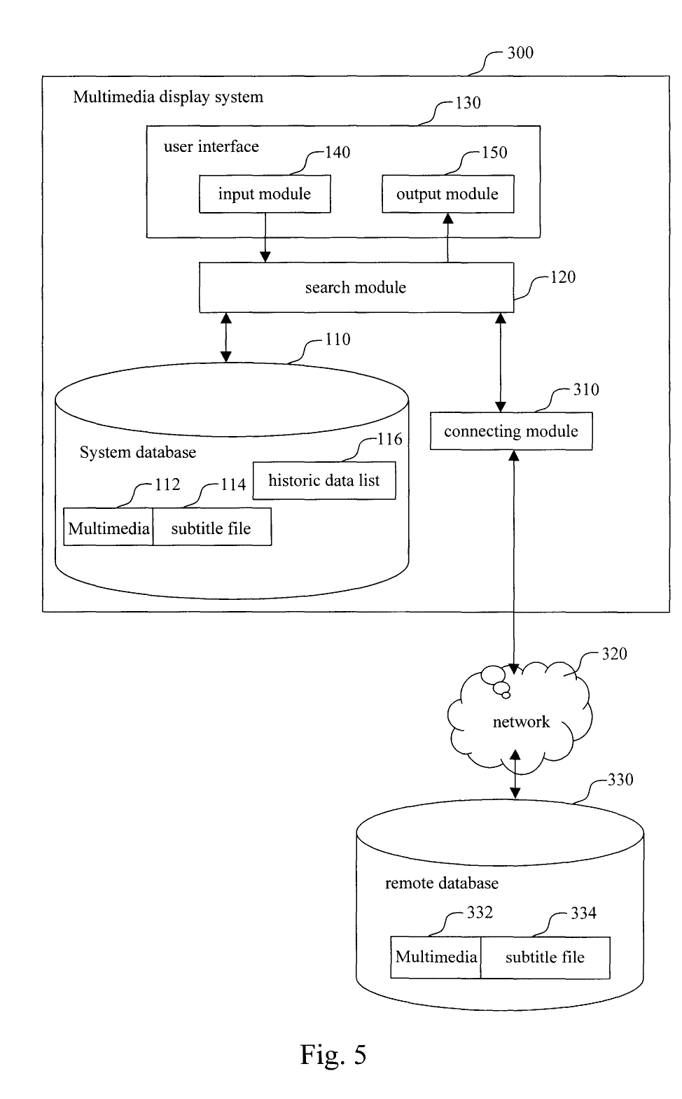

Please refer to FIG. 5. FIG. 5 is a block diagram of a multimedia system according to one preferred embodiment of this invention. The multimedia system 300 includes a connecting module 310 for connecting the multimedia system 300 to a remote database 330 via the network 320. There are at least a multimedia 332 and its subtitle file 334 stored in the remote database 330. When the data searched by the user cannot be found in the system database 110, the multimedia system 300 may retrieve the multimedia 332 and its subtitle file 334 required by the user by the connecting module 310 to request the remote database 330. Please note that, the present multimedia system 300 can also support for the digital on-line search and transaction. For example, the remote database 330 may be provided by a digital multimedia content provider, such like a cable TV provider, an on-line music provider, or a network TV provider. When the user remembers only part of subtitle of a multimedia but not an exact title of the multimedia, he is able to retrieve from the remote database 330 by the present multimedia system 300. In other words, the present multimedia system 300 can be utilized as a search and purchase interface for on-line multimedia. The user may utilize a keyword to search for the subtitle of the multimedia.

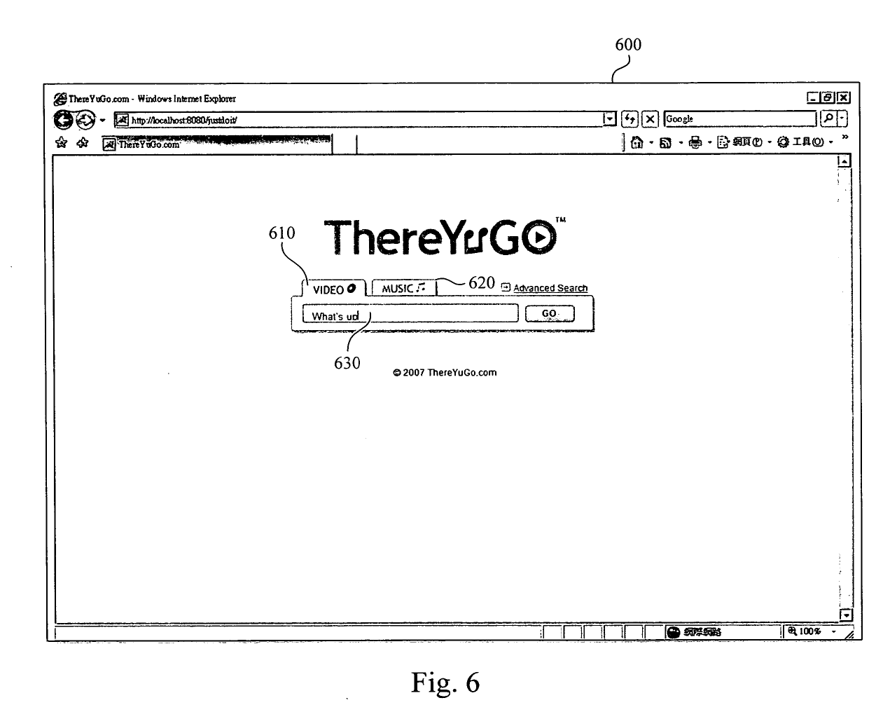

Please refer to FIG. 6. FIG. 6 is a search screen 600 for a multimedia search engine according to one preferred embodiment of this invention. As shown in FIG. 6, the search screen 600 includes an image selecting button 610, a music selecting button 620 and a keyword inputting field 630. When conducting a keyword searching on a film, the user can choose the image selecting button 610 first, inputs the keyword in the keyword inputting field 630, and vice versa. When conducting a keyword searching on a music dada, such as a MP3 format file, the user can choose the music selecting button 620 first, inputs the keyword in the keyword inputting field 630, and vice versa.

And, by connecting and searching the remote database 330 via the network 320 of FIG. 5, the multimedia 332 and its subtitle file 334 which is required by user can be obtained.

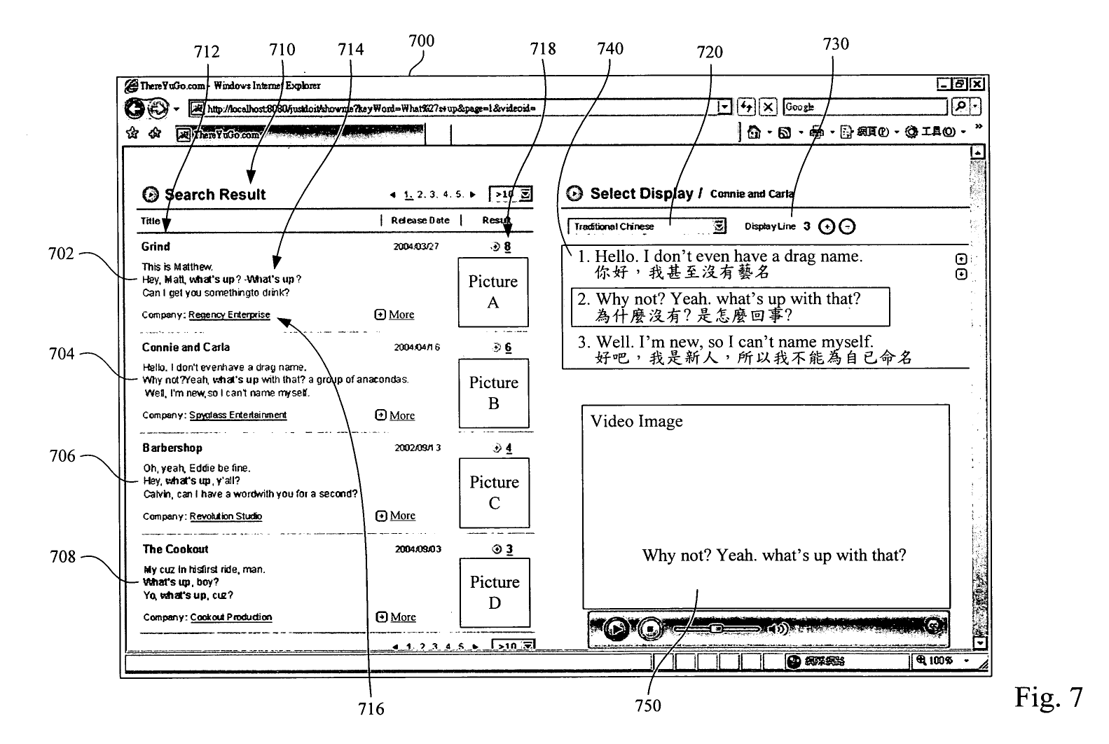

Please refer to FIG. 7. FIG. 7 is a search screen 700 for a multimedia search engine according to one preferred embodiment of this invention. As shown in FIG. 7, the search screen 700 includes a search result 710, a language selecting field 720 and a multimedia player, such as a film player 750. The search result 710 further includes a plurality of multimedia segments, such as the segments of a first film 702, a second film 704, and a third film 706 and a fourth film 708. The multimedia segments can also be a plurality of word segment of song file, which includes the keyword inputted before.

Each film segment further includes a film title 712, an example sentence 714, a production company name 716, and an appearing frequency of the keyword 718, etc. The user can choose the appearing frequency of the keyword 718 in the film, for selecting the segment from other different films which has the same appearing frequency of keyword 718. When the user chooses one segment, or a film segment predetermined by computer, such as a segment of the first film 702 with the keyword first appeared, he can replay the chosen film segment through the multimedia player 750. In addition, the search screen 700 of the present multimedia search engine further includes selection for the language selecting field 720 and appearing line number 730, so that the user can switch between different languages easily. That is, when the present multimedia search engine searches and finds the keyword, the user can switch by way of the language selecting field 720 for playing the film segments with different languages. Thus, the user can experience situated language learning having subtitle and further having voice and images, by using the present multimedia search engine. The selection for appearing line number 730 can facilitate user to choose a proper line of the example sentence 740 for clearly understanding the content and usage for the keyword.

Therefore, the user can perform data searching on remote database, which is provided by a digital multimedia provider, such like a cable TV provider, an on-line music provider, or a network TV provider, via the multimedia search engine of the present invention. When the user remembers only part of the subtitle but not an exact title of the multimedia content, he is able to search from mass subtitle data of remote database via the multimedia search engine of the present invention to retrieve required multimedia content.

In other words, the multimedia search engine of the present invention can facilitate user to search on-line multimedia content on a search and purchase interface. The user can utilize a keyword to search multimedia subtitle data and purchase the multimedia he wanted. According to the aforementioned preferred embodiments, the present invention has advantages as follows:

1. The present multimedia system and multimedia search engine may utilize multimedia and subtitle files as teaching material of languages. The learner can feel the tone and manner of speaking the language, such that increases the interest of study.

2. The present multimedia system and multimedia search engine may search by a keyword. Besides, the user may repeatedly view the multimedia segment and its subtitle that includes the keyword, such that increases the learning effects.

3. With the present multimedia system and multimedia search engine, the user may control the length played by the system, such that the content preceding and following the segment may be utilized to increase the learning efficiency. Besides, the user may review the multimedia segments and their subtitles that have been retrieved at any time without repeat the searching.

4. The present multimedia system and multimedia search engine provides a translation module or a language selection function to translate the keyword into different languages. The present multimedia system may display words of different languages at the same time, such that increases the convenience of the user to study languages.

5. The present multimedia system and multimedia search engine may retrieve the multimedia and its subtitle file required by the user via a remote database. Besides, the present multimedia system may support the digital network search and on-line transaction.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multimedia system, comprising:
a system database, for storing at least one multimedia data and a subtitle file of the multimedia data, wherein the subtitle file comprises start times and subtitles of a plurality of segments of the multimedia data;
a keyword input module, for inputting a keyword;
a search module, for utilizing the keyword to search the system database for finding a start time of a segment that comprises the keyword;
a search result displayer, for displaying a data set of the search result of the search module;
a multimedia playing unit, for playing a segment that comprise the keyword;
a subtitle playing unit, for playing subtitles of the segment that comprise the keyword;
a segment length input unit, for controlling a length of a segment and a length of a subtitle output by the subtitle playing unit; and
a multimedia title displayer, for displaying a title of multimedia data being played by the multimedia playing unit.

2. The multimedia system of claim 1, wherein the system database comprises a historic data list, for storing part of the data set.

3. The multimedia system of claim 2, further comprising a historic data displayer, for displaying data of the historic data list.

4. The multimedia system of claim 1, wherein the subtitle file comprises subtitles of languages as English, Chinese, Japanese, Korean, Russian, German, French, Arabic, Italian, Portuguese and Spanish.

5. The multimedia system of claim 1, further comprising a translation module for converting language of the keyword.

6. The multimedia system of claim 1, wherein the subtitle file is encoded by Unicode.

7. The multimedia system of claim 1, wherein the content of the multimedia data is chosen from static images, dynamic images, sounds and groups of the same.

8. A method for playing multimedia data, the method comprising:
storing at least one multimedia data and a subtitle file of the multimedia data in a system database, wherein the subtitle file comprises start times and subtitles of a plurality of segments of the multimedia data;
inputting a keyword;
searching a start time and subtitle of a segment that comprises the keyword in the system database by utilizing the keyword; and
repeatedly outputting the segment and the subtitles that comprise the keyword.

9. The method of claim 8, wherein the subtitle file comprises subtitles of languages as English, Chinese, Japanese, Korean, Russian, German, French, Arabic, Italian, Portuguese and Spanish.

10. The method of claim 8, further comprising converting language of the keyword

11. The method of claim 8, wherein the subtitle is encoded by Unicode.

12. The method of claim 8, wherein content of the multimedia data is chosen from static images, dynamic images, sounds and groups of the same.

13. A multimedia search engine, comprising:
providing a search screen, for inputting a keyword;
searching a multimedia database according to the keyword, wherein at least one multimedia data and its subtitle file are stored in the multimedia database, and the subtitle file comprises start times and subtitles of a plurality of segments of the multimedia data; and
displaying a search result screen, for displaying a search result, the search result including the plurality of segments of the multimedia data with the keyword in the multimedia database.

14. The multimedia search engine of claim 13, further comprising a multimedia player for playing the plurality of segments.

15. The multimedia search engine of claim 13, wherein search result includes a plurality of film data.

16. The multimedia search engine of claim 15, wherein each of the film data further includes a film title, an example sentence and a production company name.

17. The multimedia search engine of claim 16, wherein each of the film data further includes an appearing frequency of the keyword.

18. The multimedia search engine of claim 13, wherein the search result screen further includes a language selecting field.

19. The multimedia search engine of claim 13, wherein the search result screen further includes an appearing line number.

20. The multimedia search engine of claim 13, wherein the subtitle file comprises subtitles of languages as English, Chinese, Japanese, Korean, Russian, German, French, Arabic, Italian, Portuguese and Spanish.

21. The multimedia search engine of claim 13, wherein the subtitle file is encoded by Unicode.

22. The multimedia search engine of claim 13, wherein the content of the multimedia data is chosen from static images, dynamic images, sounds and groups of the same.
